(19) United States
(12) Patent Application Publication
(10) Pub. No.: US 2012/0042548 A1
(43) Pub. Date: Feb. 23, 2012

(54) COMMEMORATIVE PLAQUES AND METHODS OF MAKING THE SAME

(76) Inventor: Byron Joseph, II, La Mesa, CA (US)

(21) Appl. No.: 13/207,349

(22) Filed: Aug. 10, 2011

Related U.S. Application Data
(60) Provisional application No. 61/372,823, filed on Aug. 11, 2010.

(51) Int. Cl. G09F 19/00; B32B 37/12; B32B 37/24

(52) U.S. Cl. 40/124.5; 156/242

(57) ABSTRACT

A commemorative plaque, designed to display memorabilia, and method of manufacture are provided. The plaque can include an encapsulation layer that overlies and surrounds memorabilia and other component layers, providing the plaque sufficient protection from breaking due to impacts, as well as preventing the memorabilia from becoming detached. The memorabilia and a mat layer may be coupled to the top surface of a transparent base layer. A text layer can be coupled to the bottom surface of the base layer. The combination of the transparent base layer and the encapsulation layer formed on top of the memorabilia and other components renders a suspended appearance to the memorabilia and creates a desirable “shadowbox” visual effect.

### CROSS-REFERENCE TO RELATED APPLICATIONS

This disclosure claims priority to U.S. Provisional Patent Application No. 61/372,823 filed Aug. 11, 2010, titled “COMMEMORATIVE PLAQUES AND METHODS OF MAKING SAME,” and assigned to the assignee hereof. The disclosure of the prior application is considered part of, and is incorporated by reference in, this disclosure.

### BACKGROUND

1. Field

This invention relates generally to plaques. More particularly, this application relates to commemorative plaques configured to display memorabilia, for example, military insignia, and the methods of making the same.

2. Description of the Related Art

Commemorative plaques are often used to display one's memorabilia. Such plaques may be used to display memorabilia, for example, athletic awards, scholastic achievements, and/or military insignia. Plaques are frequently displayed in a vertical orientation and either mounted on a wall (or other suitable base) or are self-standing on a table or shelf. In this way, the memorabilia or achievements displayed therein and/or thereon are readily viewable and aesthetically pleasing. Thus, commemorative plaques may make great awards, gifts, or keepsakes.

Frequently, commemorative plaques display memorabilia within a frame, where the memorabilia is affixed to a backing and placed below a sheet of clear glass so it can be seen. However, the memorabilia is susceptible to becoming detached from the backing in these plaques. Additionally, the plaques are susceptible to breaking. A mere layer of glass does not provide sufficient protection in many situations, for example, when the plaques are packed up and shipped, when they are sent to someone, and/or when the owner moves frequently. Further, the plaques are not adequately protected from simple day-to-day incidents, for example, the plaque being knocked over or falling from its display location. Plaques are commonly displayed on naval ships, for example, and are susceptible to falling and breaking during rough seas.

Accordingly, a plaque that is less susceptible to breaking, that holds the memorabilia in place, and that is protective of the displayed memorabilia, while still allowing memorabilia to be clearly viewed, is needed.

### SUMMARY

The devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments,” one will understand how the features of the embodiments described herein provide advantages over other commemorative plaques.

According to some embodiments, a commemorative plaque includes a frame including a peripheral side wall defining a cavity having a lower portion and an upper portion, the lower portion of the cavity having a larger lateral dimension than the upper portion of the cavity as defined by the frame, the frame having a front side with a front surface and a back side, wherein the frame side wall includes a surface inside the frame and disposed along at least a portion of the frame side wall substantially parallel to the frame front surface and along the top of the lower portion of the cavity. The plaque also can include a transparent base layer disposed inside the frame in the lower portion of the cavity, the base layer including a top surface disposed towards the frame front side and a bottom surface. In some implementations the base layer is rigid, and can be transparent (e.g., visually appear clear) or translucent, to provide a unique visual effect of creating a shadow under the memorabilia placed thereon appear such that it appears to be offset from the backing layer even if it is coupled to the base layer. In some implementations, a spacer is disposed between the memorabilia and the base layer to provide an enhanced offset visual effect. The plaque can further include a text layer disposed inside the frame adjacent to the bottom surface of the base layer, a mat layer disposed inside the frame, the mat layer including an upper surface, a lower surface, and at least one aperture extending from the upper surface to the lower surface of the mat layer, the lower surface of the mat layer being disposed adjacent to the top surface of the base layer and the top surface of the mat layer being disposed along the surface inside the frame, and at least one piece of memorabilia positioned over the top surface of the base layer and positioned at least laterally within the at least one aperture of the mat layer. In some implementations, the mat layer includes two or more mats each having at least one aperture therein.

The plaque further includes an encapsulation layer disposed inside the frame in part of the lower portion of the cavity in at least part of the upper portion of the cavity, the encapsulation layer including a substantially transparent cured liquid, the encapsulation layer having an outer surface disposed towards the front side of the frame, the encapsulation layer covering at least a portion of the at least one piece of memorabilia and the mat layer. In some implementations, the outer surface of the encapsulation layer, that is disposed towards the front of the frame and adjacent to a front surface defined by the front of the frame, is set back from the front surface of the frame by between about 0.01″ and about 1″. In some implementations, the outer surface of the encapsulation layer, that is disposed towards the front of the frame and adjacent to a front surface defined by the front of the frame, is set back from the front surface of the frame by between about 0.01″ and about ¼″. In some implementations, the outer surface of the encapsulation layer, that is disposed towards the front of the frame and adjacent to a front surface defined by the front of the frame, is level with the frame. This configuration can protect the outer surface of the encapsulation layer. The plaque can also include a cushioning layer disposed inside the frame and adjacent to the text layer such that the text layer is between the cushioning layer and the base layer, and a back plate disposed adjacent to the cushioning layer on the opposite side of the cushioning layer than the text layer.

In some implementations, the base layer comprises a rigid material having a thickness dimension from a top surface of the base layer to a bottom surface of the base layer of between about 1 mm and about 25 mm. In some implementations, the base layer can be translucent or opaque, and have a color. In such implementations, the text layer can be disposed above the base layer such that the text is not covered by the base layer when the plaque is viewed from the front of the frame viewpoint. In some implementations, the frame side wall includes at least one groove interior to the frame, and at least one of the at least one of the base layer, the text layer, the mat layer, the cushioning layer, and the back plate is disposed inside the groove. The back plate can be removably coupled to the frame using latching elements, and/or can include a movable stand structure that partially supports the plaque when placed upright on a desk, table, or other flat surface. The commemorative plaque can further include an adhesive, disposed on at least part of the frame side wall, coupling the upper surface of the mat layer and/or the base layer, to the frame side wall. In some implementations, the commemorative plaque can further include at least one spacer element disposed between the base layer and the at least one piece of memorabilia. In some implementations, the encapsulation layer encapsulates the surfaces of the at least one piece of memorabilia that are not attached to the spacer. The encapsulation layer can also cover the top surface of the base layer that is not covered by the mat layer or the at least one piece of memorabilia. The encapsulation layer can also cover the upper surface of the mat layer that is not covered by the frame. In some implementations, the substantially transparent cured liquid comprises an acrylic resin. In some implementations, the substantially transparent cured liquid comprises two-part epoxy resin. The peripheral side wall can be shaped as a rectangular, oval, circle or another suitable shape.

In another implementation, a method of making a commemorative plaque includes one or more of the following: providing a frame that includes a peripheral side wall defining a cavity having a lower portion and an upper portion, the lower portion of the cavity having a larger lateral dimension than the upper portion of the cavity as defined by the frame, the frame having a front side with a front surface and a back side, wherein the frame side wall includes a surface inside the frame and disposed along at least a portion of the frame side wall substantially parallel to the frame front surface and along the top of the lower portion of the cavity, coupling a mat layer to the frame such that an upper surface of the mat layer is disposed along the surface inside the frame, the mat layer including a lower surface and at least one aperture extending from the upper surface to the lower surface of the mat layer disposing a transparent base layer having a top surface and the bottom surface inside the frame in the lower portion of the cavity such that the top surface of the base layer is adjacent to the lower surface of the lat layer, attaching at least one piece of memorabilia over a top surface of a base layer such that the at least one piece of memorabilia is positioned at least laterally within the at least one aperture of the mat layer, coupling a substantially transparent base layer to at least one of the lower surface of the mat layer and the frame side wall, pouring a generally transparent curable liquid through the front of the frame to cover visible portions of the mat layer, the at least one piece of memorabilia, and the base layer, such that wherein the top of the poured liquid is set back from the front surface of the frame by between about 0.01″ and about 1″, and allowing the generally transparent curable liquid to solidify forming an encapsulation layer surrounding the visible portions of the mat layer, the at least one piece of memorabilia, and the base layer. The method can also include positioning a cushioning layer inside the frame and adjacent to the text layer such that the text layer is between the cushioning layer and the base layer, and positioning a back plate adjacent to the cushioning layer on the opposite side of the cushioning layer than the text layer. In such methods, the base layer can be a rigid material having a thickness dimension between about 1 mm and about 25 mm. Also, the generally transparent curable liquid can be poured in a series of layers, for example, in two of more layers each having a thickness dimension of between about 1/32″ and about ½″. In some implementations, the generally transparent curable liquid can be poured in a series of layers of between about 1/16″ and about ⅛″. The above-listed parts of manufacturing may also be performed in a different order, or with additional steps or less steps.

According to one embodiment, a plaque includes a frame having a cavity having a first upper portion and a second lower portion, said second portion defining a bottom internal surface within said frame, a base layer comprising a top surface and a bottom surface, wherein said top surface comprises a first area and a second area, wherein said base layer is disposed within said second cavity portion, a mat layer, wherein said mat layer is disposed above said first area and adjacent to said bottom internal surface, a text layer, wherein said text layer is disposed below said bottom surface of said base layer, at least one piece of memorabilia, wherein said memorabilia is disposed over said second area, and an encapsulation layer, disposed within said first cavity portion and at least partially above said mat layer and said memorabilia and said first layer, wherein an outer surface of the encapsulation layer is below or set back from the front surface of the frame. In some embodiments, the top of the encapsulation layer is between about 0.01″ and about 1″ below, or set back from, the front surface of the frame.

In another embodiment, a plaque includes a frame comprising a cavity having a first upper portion and a second lower portion, said second portion defining a bottom internal surface within said frame, said bottom internal surface comprising at least one groove, a base layer comprising a top surface and a bottom surface, wherein said base layer is disposed within said second cavity portion, a mat layer comprising an opening extending through said mat layer and a top surface and bottom surface, wherein said mat layer is disposed within said second cavity portion, said bottom surface of said mat layer is coupled to said top surface of said base layer, and said top surface of said mat layer is coupled to said bottom internal surface of said frame, a text layer, wherein said text layer comprises text and is disposed within said second cavity portion and coupled to said bottom surface of said base layer, at least one piece of memorabilia, wherein said memorabilia is coupled to said top surface of said base layer within the opening of said mat layer, caulk, wherein said caulk is disposed between said mat layer and said frame, an encapsulation layer, wherein said encapsulation layer is disposed within said first cavity portion, below a front edge of the frame, and above said mat layer and said memorabilia and said base layer, a cushioning layer, wherein said cushioning layer is disposed within said second cavity portion and below said text layer, and a back plate, wherein said back plate is disposed within said second cavity portion and below said cushioning layer, and wherein at least a portion of said back plate is received by said at least one groove.

In another embodiment, a method of making a plaque includes A method of making a commemorative plaque, includes providing a frame that includes a peripheral side wall defining a cavity having a lower portion and an upper portion, the lower portion of the cavity having a larger lateral dimension than the upper portion of the cavity as defined by the frame, the frame having a front side with a front surface and a back side, wherein the frame side wall includes a surface inside the frame and disposed along at least a portion of the frame side wall substantially parallel to the frame front surface and along the top of the lower portion of the cavity, coupling a mat layer to a transparent base layer such that a lower surface of the mat layer is coupled to the upper surface of the base layer, coupling a text layer to a bottom surface of the base layer, attaching at least one piece of memorabilia positioned to the top surface of the base layer such that the at least one piece of memorabilia is positioned at least laterally within the at least one aperture of the mat layer, placing an adhesive along at least a portion of said surface inside the frame, attaching the mat layer, the base layer and the text layer into frame such that the top surface of the mat layer is positioned against the surface inside the frame, pouring a generally transparent curable liquid through the front of the frame to cover visible portions of the mat layer, the at least one piece of memorabilia, and the base layer, such that wherein the top of the poured liquid is set back from the front surface of the frame by between about 0.01″ and about 1″, and allowing the generally transparent curable liquid to solidify forming an encapsulation layer surrounding the visible portions of the mat layer, the at least one piece of memorabilia, and the base layer.

### BRIEF DESCRIPTION OF THE DRAWINGS

FIG. 1A is a front view schematically illustrating an example of a commemorative plaque according to one embodiment.

FIGS. 1B-1K illustrate examples of memorabilia arrangements on commemorative plaques.

FIG. 2A is a side view schematically illustrating an example of a text layer with text on it.

FIG. 2B is a side view schematically illustrating an example of a cushioning layer.

FIG. 2C is a side view schematically illustrating an example of the back plate.

FIG. 2D is a side view schematically illustrating an example of an encapsulation layer shown in FIG. 1.

FIG. 2E is a side view schematically illustrating an example of a mat layer shown in FIG. 1.

FIG. 2F is a side view schematically illustrating an example of a memorabilia shown in FIG. 1 on the top side of the base layer.

FIG. 2G is a side view schematically illustrating an example of a frame, such as shown in FIG. 1, including a cavity configured to receive at least a portion of a back plate, cushioning layer, base layer, mat layer, text layer, encapsulation layer, and memorabilia.

FIG. 2H is a side view schematically illustrating an example of components of a commemorative plaque including spacer elements disposed between the memorabilia and the base layer.

FIG. 3A is a side view schematically illustrating examples of components of FIGS. 2A-2F disposed adjacent to the cavity of the frame of FIG. 2G.

FIG. 3B is a side view schematically illustrating examples of the components illustrated in FIG. 3A disposed within the frame.

FIG. 4 is a front view schematically illustrating an example of another embodiment of a plaque.

FIG. 5 is a side view schematically illustrating components of another embodiment of a commemorative plaque including spacer elements disposed between the memorabilia and the base layer.

FIG. 6 is a flowchart schematically illustrating an example of a method for making a commemorative plaque.

FIG. 7 is a flowchart schematically illustrating another example of a method for making a commemorative plaque.

### DETAILED DESCRIPTION OF CERTAIN EMBODIMENTS

The following detailed description is directed to certain specific embodiments of the invention. However, the invention can be embodied in a multitude of different ways. For example, different memorabilia may be incorporated in plaques to further display and commemorate accomplishments or achievements. Plaques may vary in size depending on the memorabilia to be contained and where the plaque is to be displayed. Different features may be incorporated in plaques to further protect the plaques and/or provide alternate display features. In this description, reference is made to the drawings wherein like parts may be designated with like numerals throughout.

In embodiments described herein, a commemorative plaque (referred to sometimes herein simply as a “plaque”) includes a frame into which other components of the plaque are placed and secured. For example, in one embodiment the plaque includes memorabilia which can be any item or items that fit within the frame. The back (e.g., non-display or less desired display) side of the memorabilia can be attached to a base layer (e.g., glass). The plaque can also include a mat positioned over the base layer and surrounding the memorabilia. The mat and base layer (supporting the memorabilia) are attached and sealed into the frame. The plaque can also include a transparent protective encapsulation layer (e.g., acrylic, epoxy resin) formed over the memorabilia and configured to be at or below the front side of the frame, such that the encapsulation layer provides the general appearance of glass but it is far more robust. The encapsulation layer is formed by a fluid added over the memorabilia, which encapsulates the memorabilia and then hardens. In some implementations the encapsulation layer is formed to be at or below the front surface or a front portion of the frame so that it looks even or slightly inset into the frame. The encapsulation layer provides a rigid transparent layer that protects and holds the memorabilia in place. A piece of glass in a picture frame has two nearly perfectly parallel planar surfaces each having a glass/air interface which can generate optical aberrations that are detrimental to viewing the memorabilia positioned behind the glass. However, the encapsulation layer does not have two parallel surfaces with glass/air interfaces because the lower surface of the encapsulation layer conforms to the material (e.g., mat and memorabilia) below it, and is not disposed against air. Accordingly, the encapsulation layer does not exhibit the detrimental optical effects as frame glass.

In some embodiments of a commemorative plaque, memorabilia can be coupled to spacers which offset the memorabilia from the base layer and provide a protruding “shadow box” effect even if the base layer is opaque. Disposing the memorabilia on a glass base layer gives the memorabilia a protruding visual effect. In some embodiments, the spacers are used with a substantially transparent (e.g., glass) base layer to provide an even more pronounced protruding “shadow box” effect.

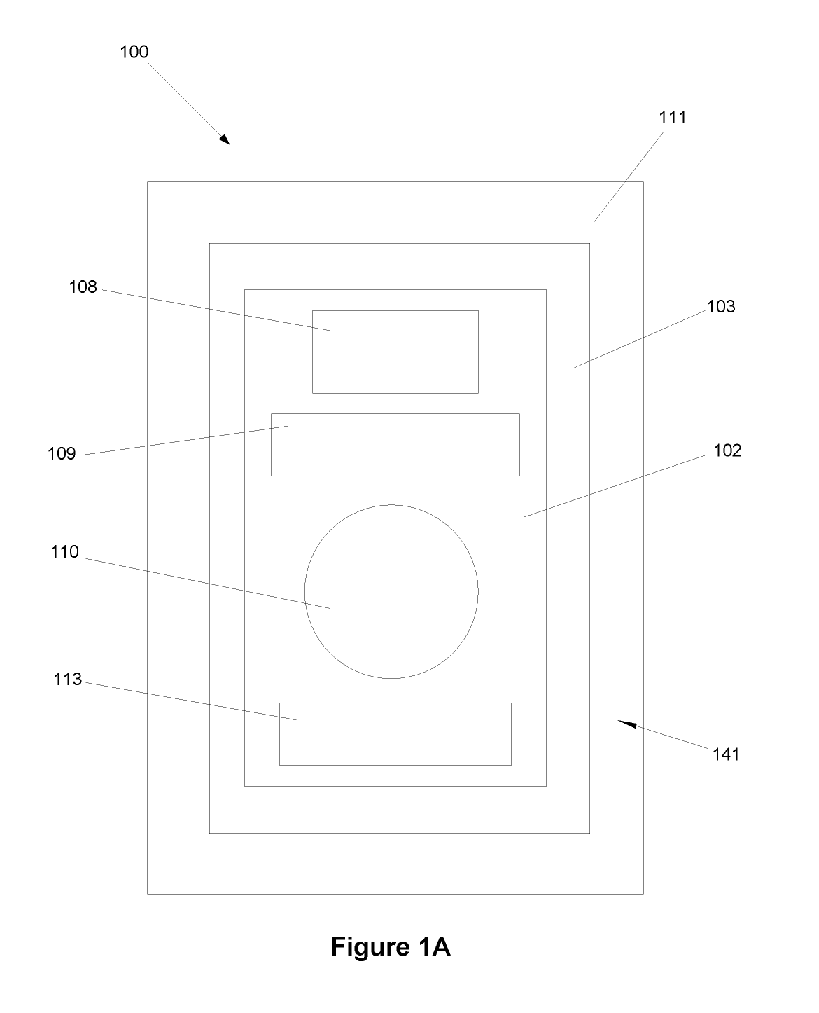

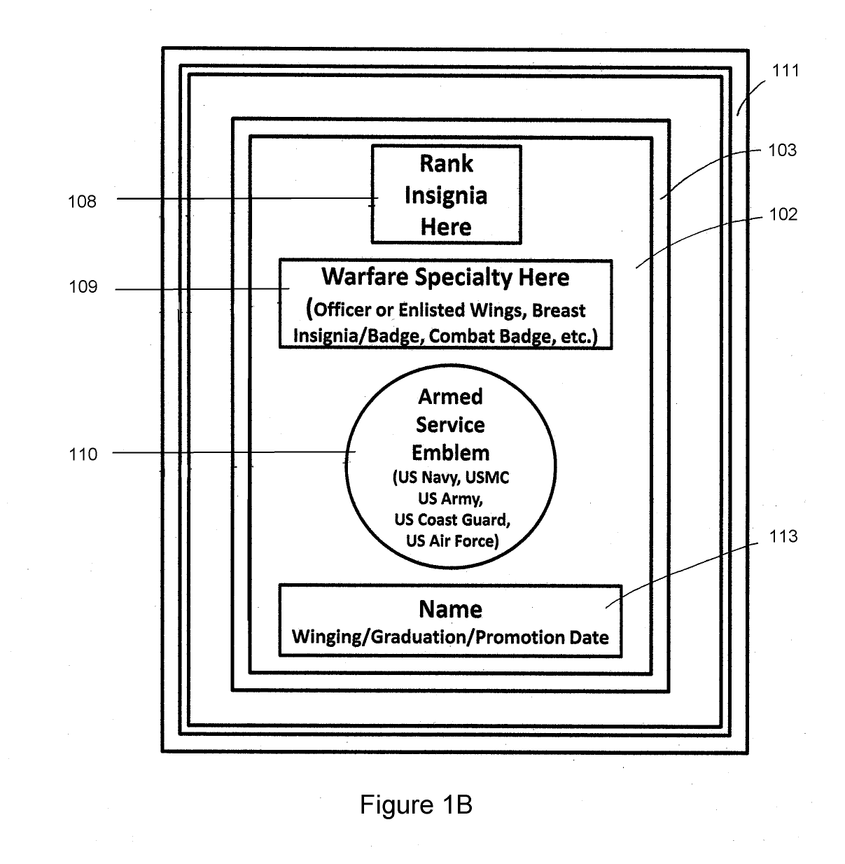

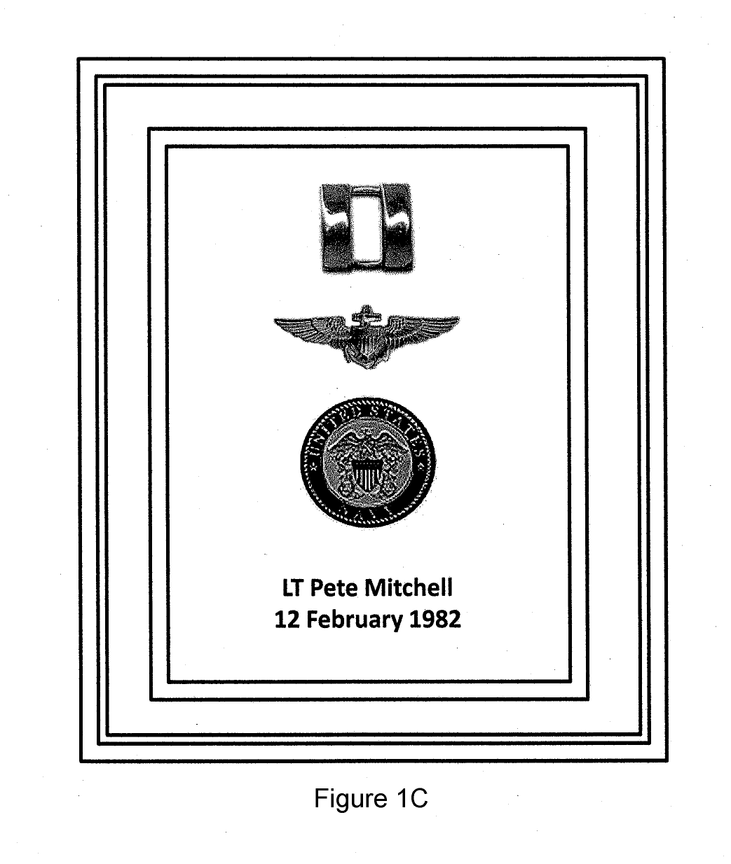

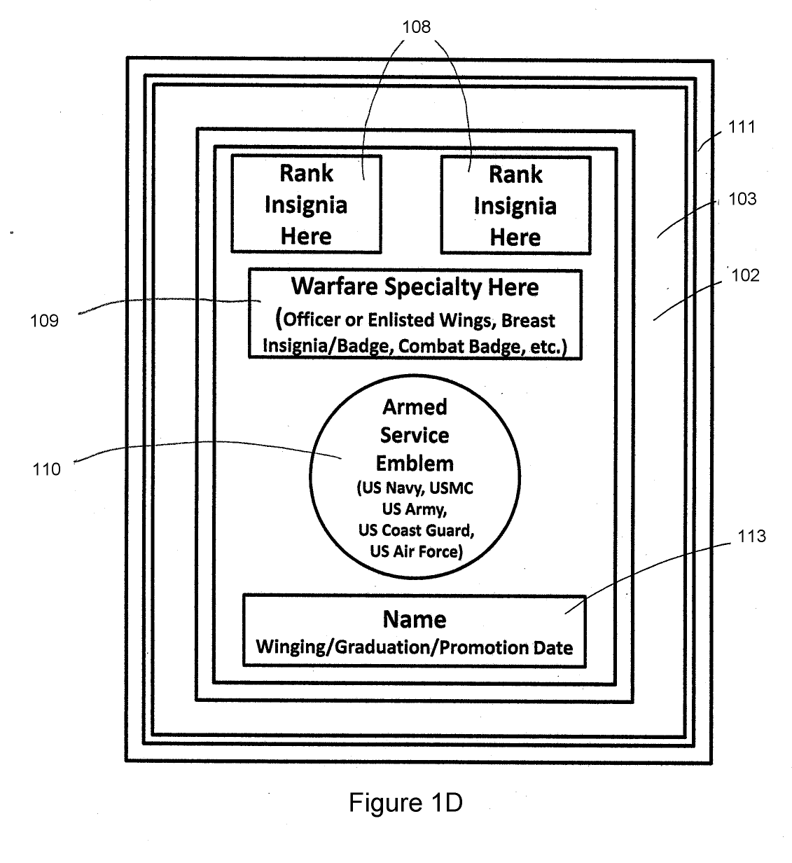

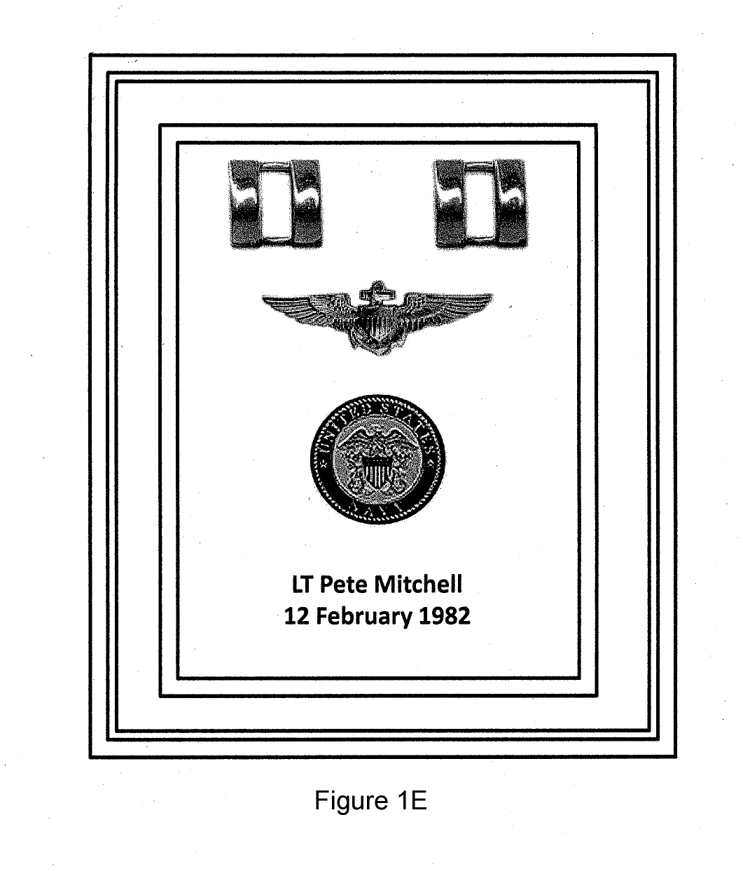

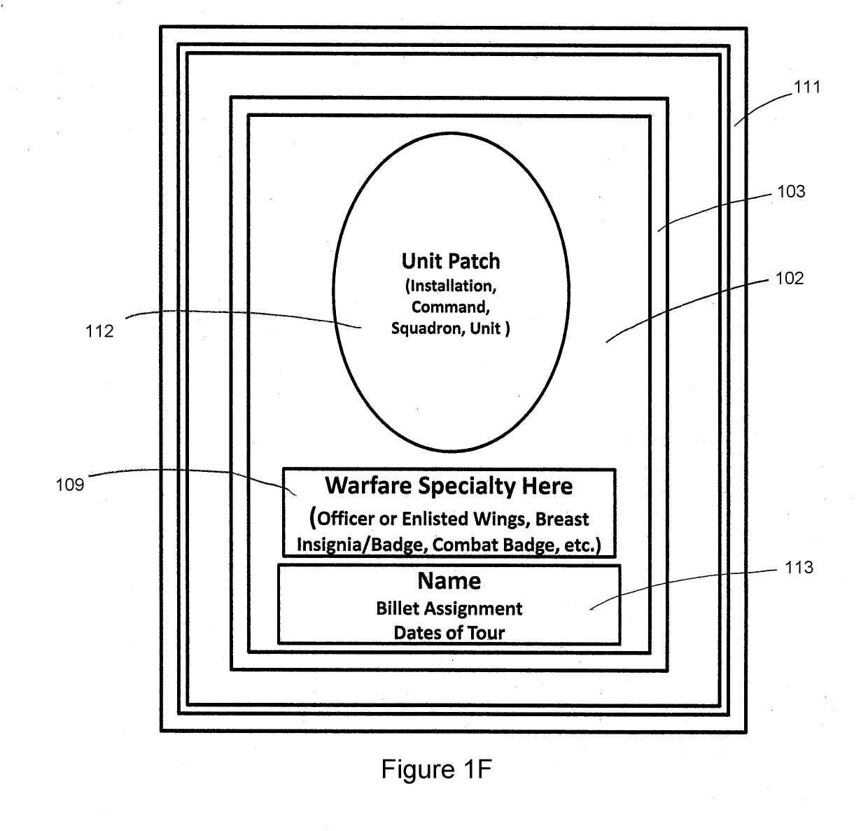

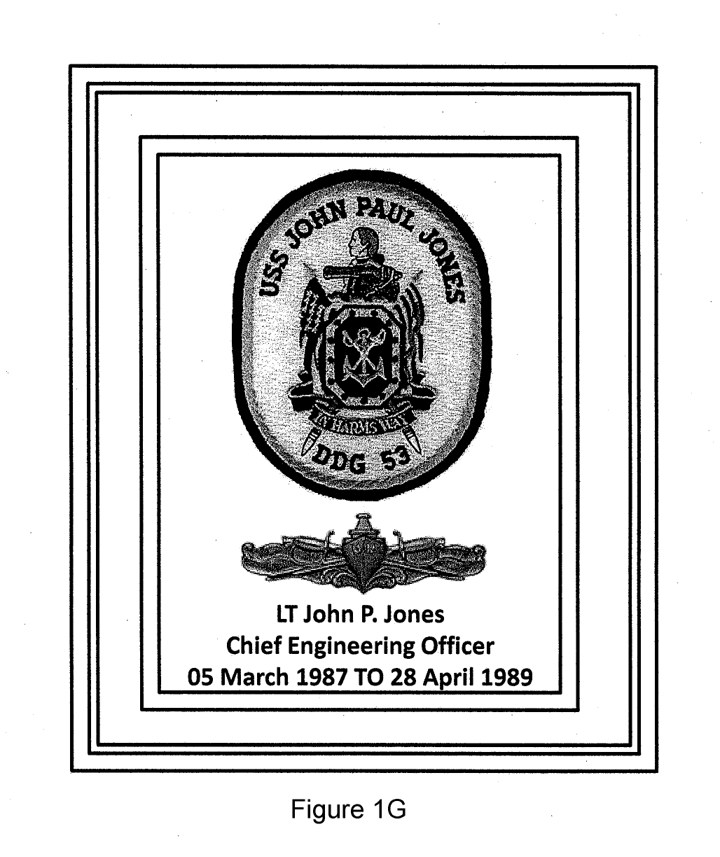

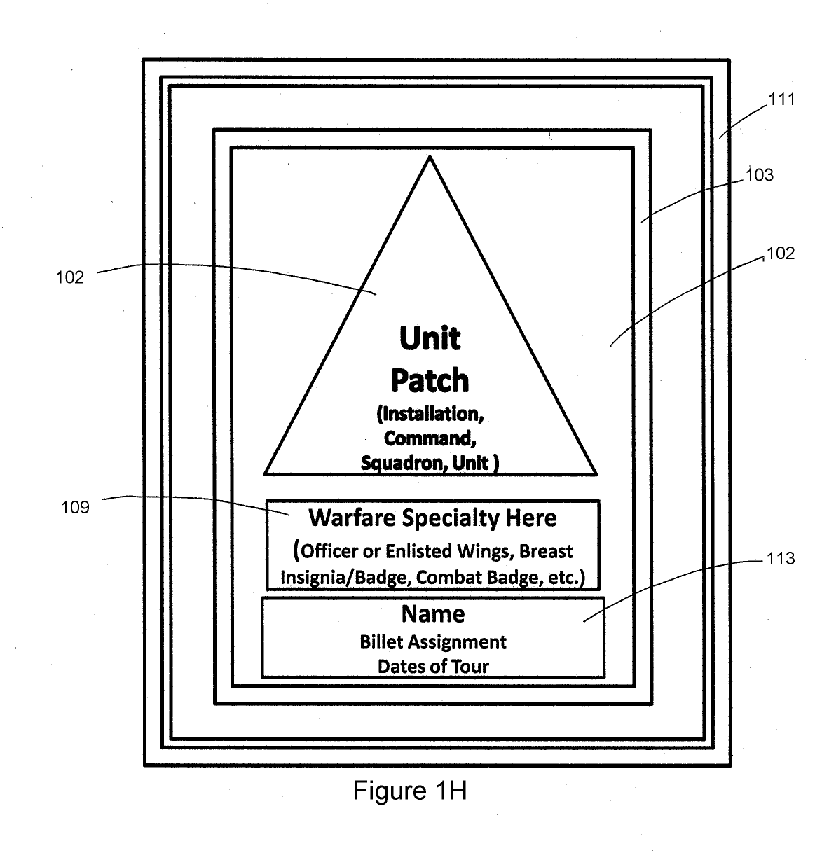

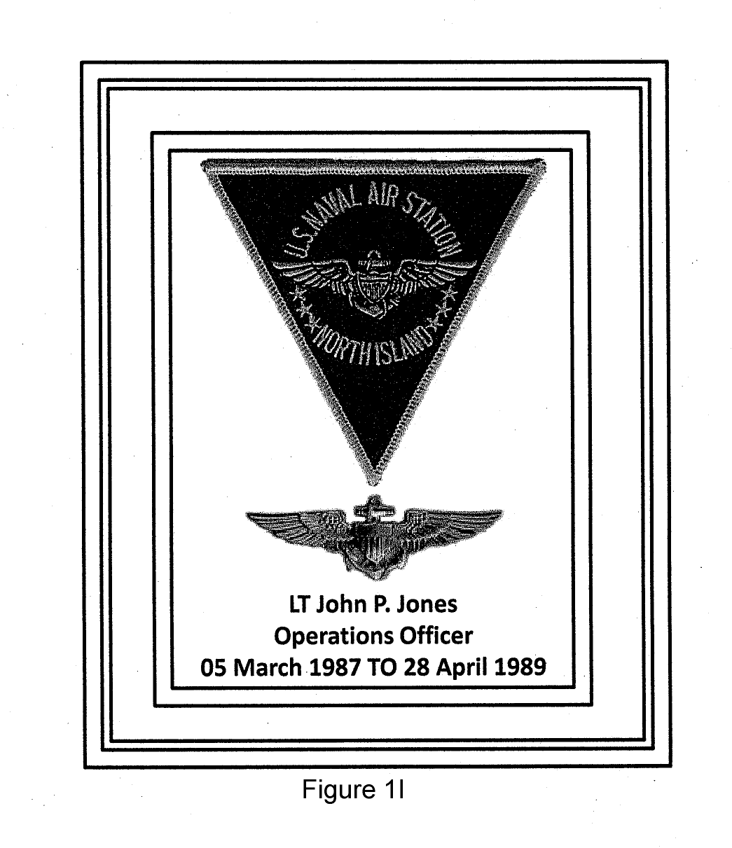

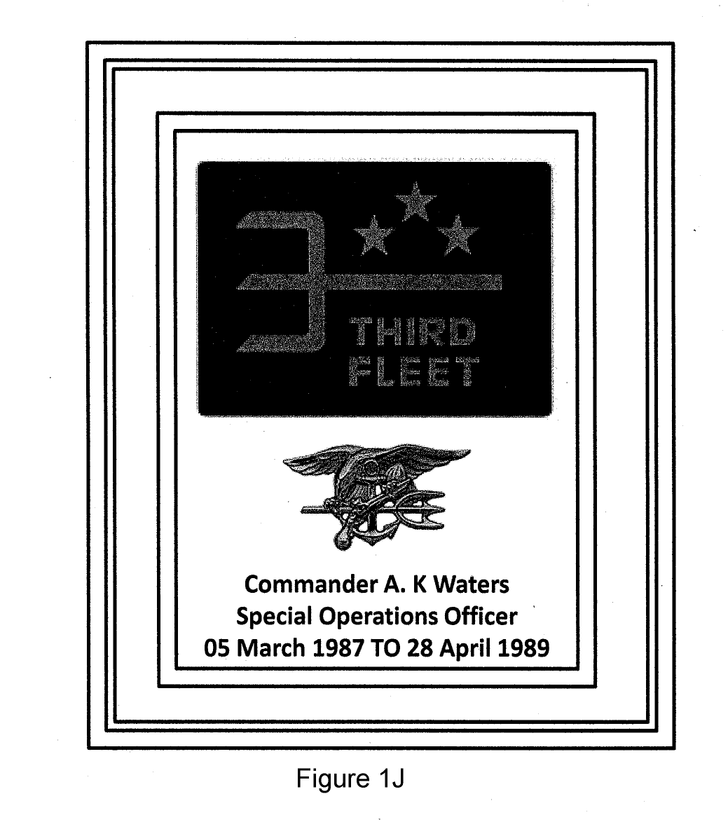

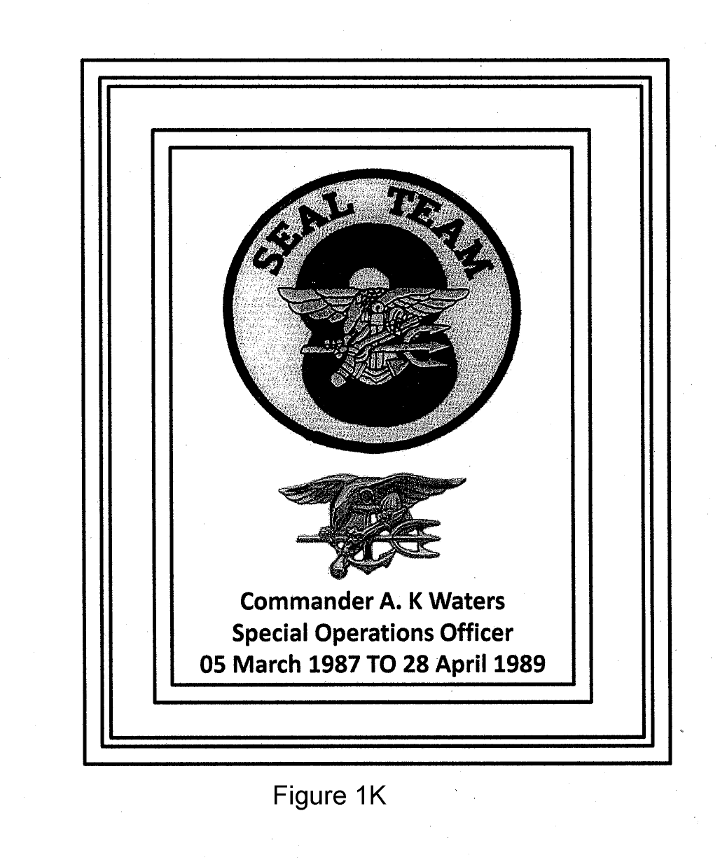

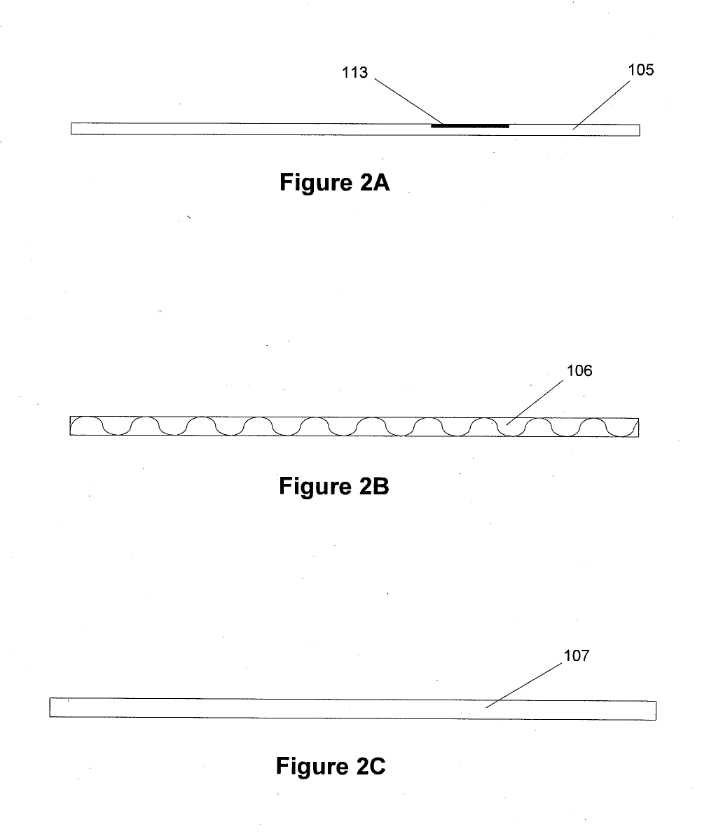

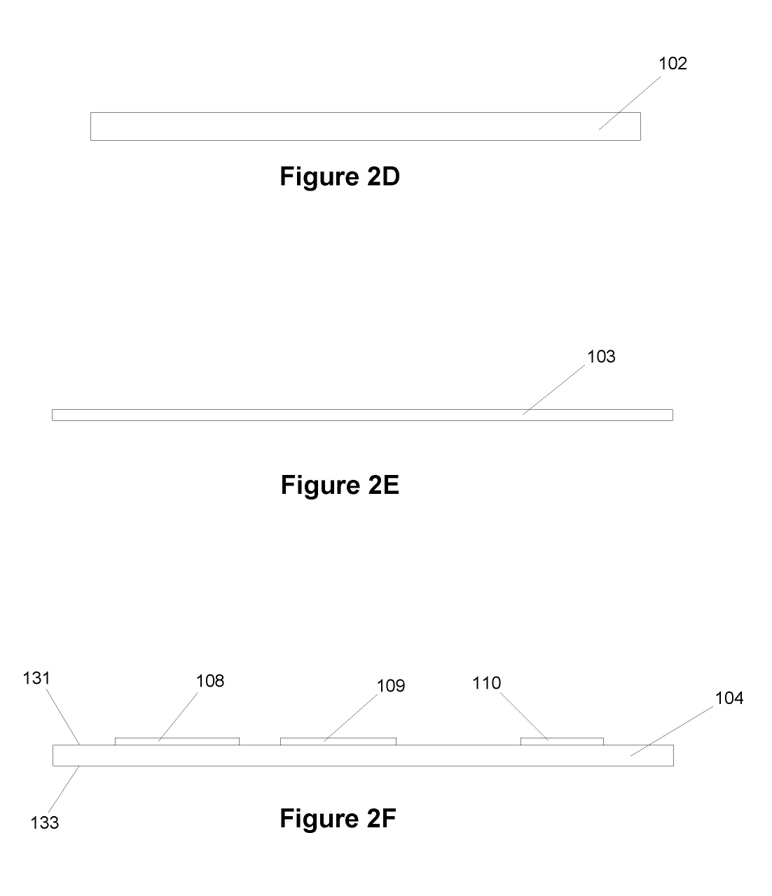

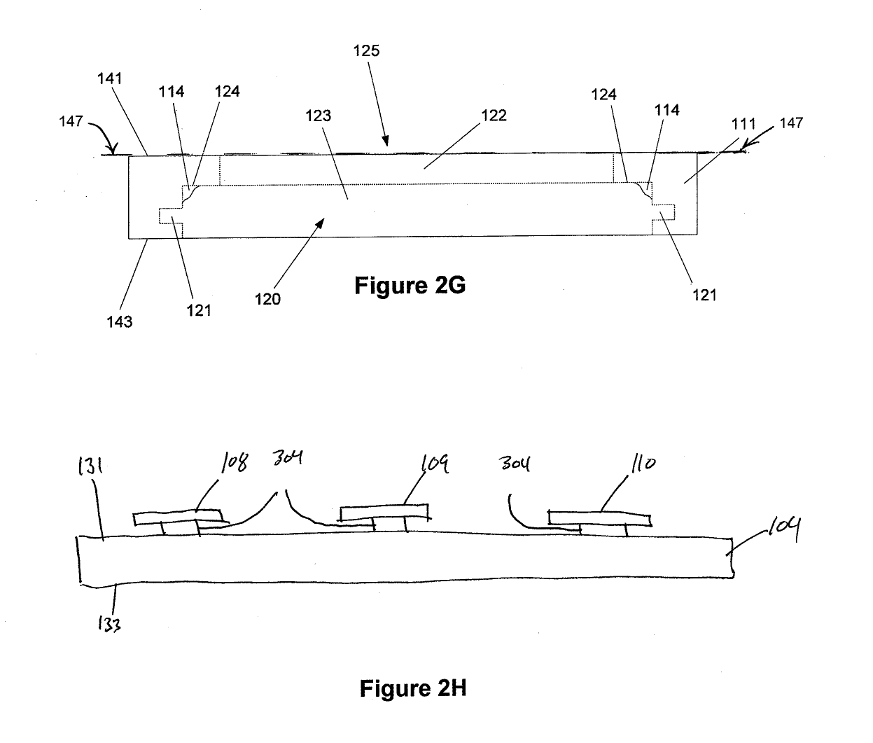

Certain aspects of embodiments of the invention are described hereinbelow with reference to the figures. FIG. 1A illustrates a front view of one embodiment of a plaque 100 that includes a frame 111 and a transparent encapsulation layer 102 disposed within the frame 111. The frame 111 includes a front side 141 that defines a front plane 147 (shown in FIG. 2G) of the frame 111. The plaque 100 also includes a mat layer 103 disposed within the frame 111 and generally underneath the encapsulation layer 102 such that the encapsulation layer 102 is between the mat layer 103 and the front plane 147 of the frame 111. The frame may be formed of various materials, typically rigid materials, for example, woods, metals, composites, and plastics.

The frame 111 (and therefore the plaque 100) can be configured in many shapes. For example, in some embodiments, frame 111 may be polygonal, for example, square or rectangular. In other embodiments, frame 111 may be generally curvilinear, for example, circular or oval shaped. The size of the frame 111 may vary depending on the size and quantity of memorabilia to be displayed and the intended use of the plaque. In some embodiments, the frame 111, when viewed from the front, may be rectangular-shaped or square-shaped with each side between about 0.75 inches and about 50 inches long. In some embodiments, the frame 111 is rectangular with length and width dimensions that are each between about 4 inches and 24 inches.

Encapsulation layer 102 is a transparent or substantially transparent material that is disposed within the frame 111 and covers at least the front of the displayed memorabilia illustrated in FIG. 1 as memorabilia 108, 109, 110. In some embodiments, the encapsulation material can be an acrylic or epoxy resin. In certain embodiments the encapsulation layer 102 covers the front and sides of the displayed memorabilia. In some embodiments, the encapsulation layer 102 can include one or more layers of either the same material or different materials. In other words, the encapsulation layer 102 can be formed by two or more layers, built-up layer by layer until the desired encapsulation layer thickness is achieved. Each layer can be formed from the same or a different transparent material(s).

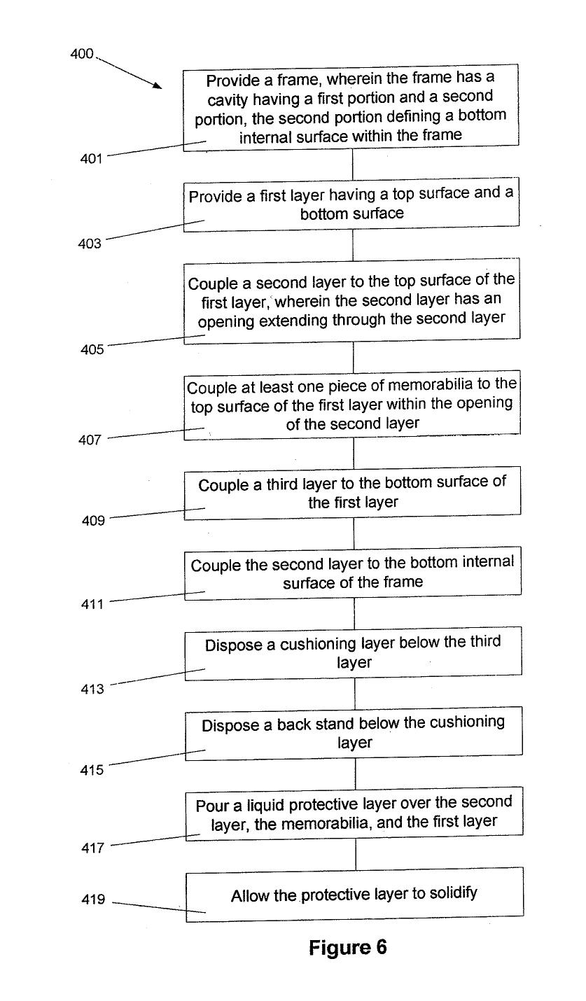

As described hereinbelow (for example, in reference to FIG. 6) the encapsulation layer 102 when placed in the frame over the memorabilia is in a fluidic state such that it can flow over and around portions, or all, of the memorabilia and into the space above the memorabilia within the frame 111. The top of the encapsulation layer 102 (the “top” being the portion of the encapsulation layer 102 closest to the front side 141 and the front plane 147 of the frame 111) is formed at or below the front plane 147 (FIG. 2G) of the frame 111 (“below” referring to a relative position that is between the front plane 147 and the memorabilia 108). In other words, the encapsulation material 102 is configured to be level with or below the front plane 147. In certain embodiments, the encapsulation layer 102 is formed such that the top of the encapsulation layer 102 is below the front plane 147 by at least about 0.01 inches, or in some embodiments by between about 0.01 and about 1.00 inches.

In some embodiments, such as illustrated in FIG. 1A, the mat layer 103 includes one or more apertures that extend through the mat layer 103. In some embodiments, the mat layer 103 includes a single mat that literally surrounds the memorabilia and adds to the aesthetic appeal of the plaque. In some embodiments, the mat layer 103 includes more than one mat, and each mat can include different sized apertures.

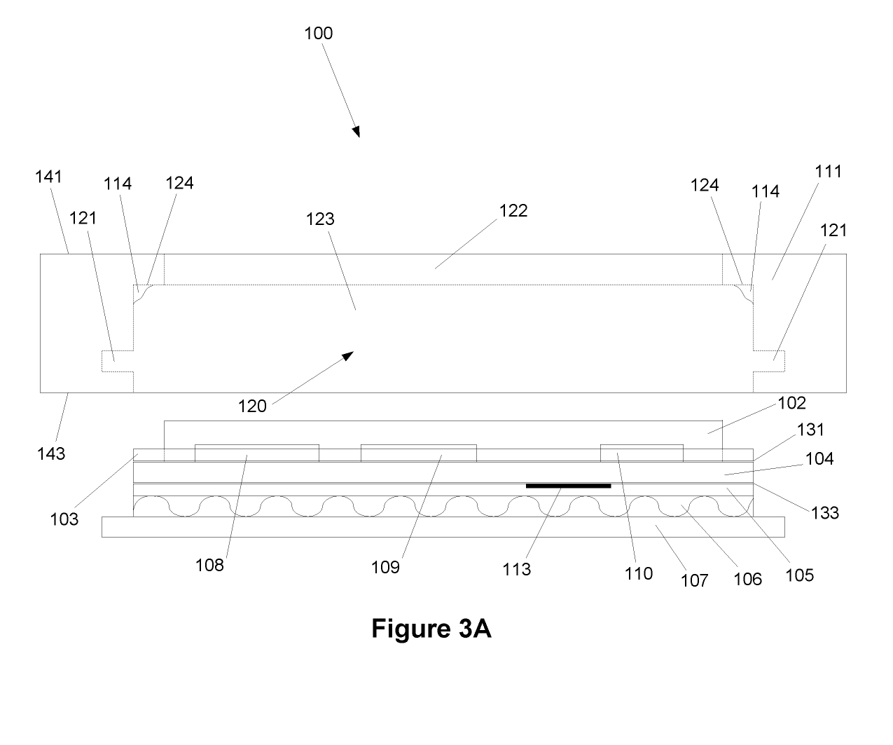

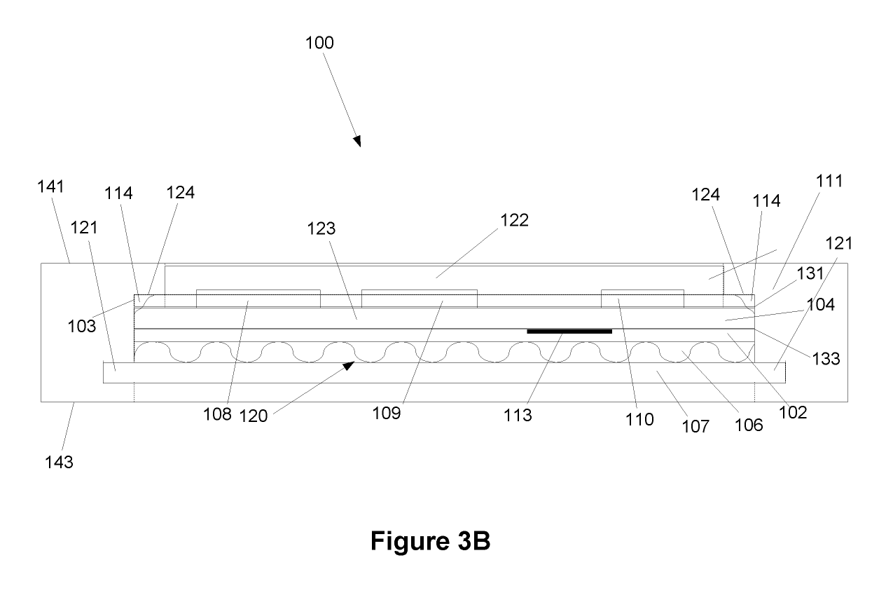

Also illustrated are memorabilia 108, 109, and 110. Memorabilia 108, 109, and 110 may be any items that someone may desire to display, for example, military rank insignia, and plaque 100 may include any number of pieces of memorabilia. Memorabilia 108, 109, and 110 may be coupled to a base layer, as described in more detail below in reference to FIGS. 2F and 3. In one embodiment, memorabilia 108 may be an officer or enlisted military rank insignia, memorabilia 109 may be an officer or enlisted warfare badge, and memorabilia 110 may be an armed service emblem, for example, U.S. Navy, U.S. Marine Corps, U.S. Army, or U.S. Coast Guard.

Plaque 100 may also contain text 113 (e.g., letters, symbols, characters, words) which can be on a material or separate pieces. Such is referred to herein as a text layer. The text layer can be disposed below the mat layer 103 (or within the mat layer 103), encapsulation layer 102, memorabilia 108, 109, 110, 113, and a base layer 104, as illustrated in FIGS. 2A and 3. The text 113 can be positioned on the text layer such that it is visible to a person viewing the plaque 100 from the front side through the encapsulation layer 102 and/or base layer and mat layer(s). In some implementations, the base layer can be opaque. In such implementations, the text layer can be disposed above the base layer between the base layer and the front side of the frame, and may only cover a portion of the base layer such that the portion of the base layer not covered by the text layer is visible when the plaque is viewed from the front side of the frame.

FIGS. 1B-1K illustrate some non-limiting examples of memorabilia arrangements. Other arrangements are also contemplated.

Referring to FIGS. 2A-2G, various examples of components of plaque 100 are schematically illustrated independently. These components are also shown together in the embodiment illustrated in FIG. 3. FIG. 2A illustrates a side view of a text layer 105. As discussed above, text layer 105 may contain text 113 that can be viewed by a viewer through the encapsulation layer 102 from the front side of the plaque 100. In one embodiment, text 113 may include a person's name and/or winging/graduation/promotion date information to accompany and enhance the memorabilia 108, 109, and 110. Text layer 105 may be formed of various materials. In one embodiment, text layer 105 is a fibrous material, for example, paper.

FIG. 2B illustrates a side view of a cushioning layer 106. Cushioning layer 106 may be formed of various materials. Examples of suitable materials include corrugated papers, cardboards, and polymers. The cushioning layer 106 provides further protection for plaque 100 and the memorabilia encapsulated in the plaque 100.

FIG. 2C illustrates a side view of a back plate 107. In one embodiment, back plate 107 may include latching elements for example, clips or fasteners, to couple back plate 107 to frame 111. In another embodiment, back plate 107 may contain a support arm (not shown), which may be used to support plaque 100 so that it may be displayed on, for example, a desk, table, or shelf without being affixed to a wall or other structure.

FIG. 2D illustrates a side view of a hardened encapsulation layer 102 that may be poured in liquid form over a surface and allowed to harden to form a boundary that protects memorabilia underneath and/or enclosed in the encapsulation layer 102 from harmful impact.

FIG. 2E illustrates a side view of mat layer 103 discussed above with reference to FIG. 1. Mat layer 103 is shown here as a single layer, however, it can include one or more mats.

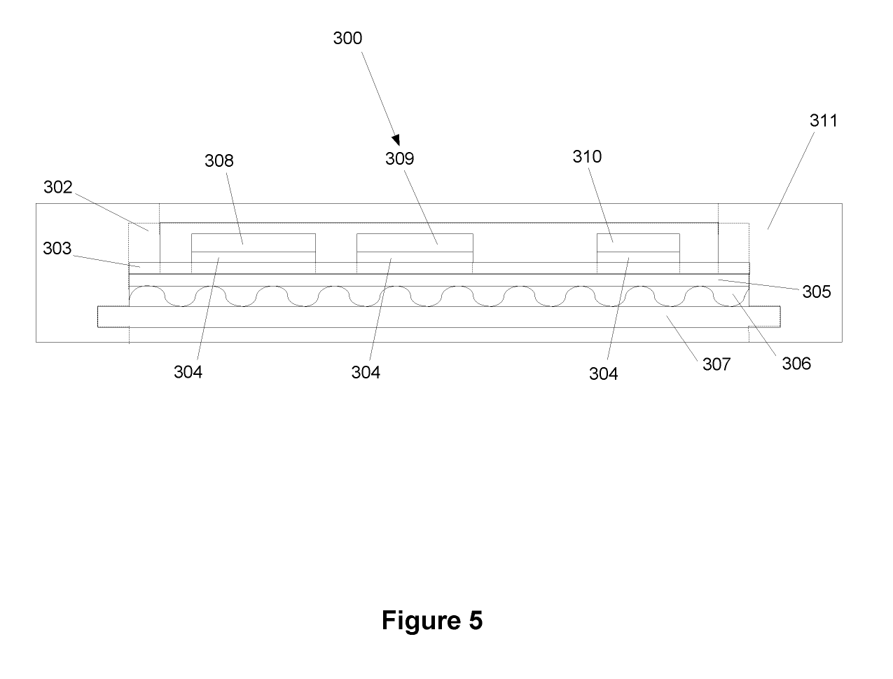

FIG. 2F illustrates a side view of base layer 104. Base layer 104 may be formed of various materials and may also be a substrate. In some embodiments, base layer 104 may be substantially optically transparent, allowing text layer 105 and text 113 to be visible through the base layer 104. In some implementations, the base layer 104 may be glass for plastic. The base layer 104 can include a top surface 131 and a bottom surface 133 disposed opposite to the top surface. When the plaque 100 is assembled, the top surface 131 can be disposed nearer to the front side of the plaque illustrated in FIG. 1 than the bottom surface 133. As mentioned above, base layer 104 may be coupled to memorabilia 108, 109, 110, for example, memorabilia 108, 109, 110 can be coupled to the top surface 131. In one embodiment, base layer 104 may be a substantially continuous layer. Another embodiment can include spacer elements 304 disposed underneath memorabilia 108, 109, 110, as illustrated in FIGS. 2H and 5. In this embodiment the encapsulation layer 102 can be formed over the top, sides and at least a portion of the bottom of the memorabilia, which helps to hold it in place.

FIG. 2G illustrates an implementation of a plaque in a side view. Frame 111 contains a cavity 120 surrounded by the frame, which can further be characterized as an upper cavity portion 122 and a lower cavity portion 123. In one embodiment, upper cavity portion 122 and lower cavity portion 123 may combine to create an opening 125 extending through frame 111 between the front side 141 of the frame and the back side 143. In another embodiment, lower cavity portion 123 may occupy a larger volume than upper cavity portion 122, resulting in a bottom internal surface 124 within frame 111 which may be sized differently in different embodiments. Frame 111 can contain at least one groove 121 disposed adjacent to the lower cavity portion 123. The groove 121 can be configured to receive at least a portion of another component of the plaque 100, for example, a portion of back plate 107 schematically illustrated in FIG. 2C. In one embodiment, the groove 121 may circumscribe at least a portion of the lower cavity portion 123. Caulk 114 can also be disposed over at least a portion of the bottom internal surface 124 to couple various substituent components of plaque 100 to the frame 111. In one embodiment, mat layer 103 may be coupled to frame 111 with caulk 114. In such embodiments, the base layer 104 can be coupled to the mat layer 103. In another embodiment, the base layer 104 may be coupled to the frame 111 with caulk 114.

FIG. 2H illustrates a side view schematically illustrating some of the components of one embodiment of frame 111. In this embodiment, the memorabilia 108, 109, 110 is coupled to the upper surface 131 of base layer 104 using spacer elements 304. The space elements 304 can include a variety of materials, dimensioned to space the memorabilia from the upper surface 131 of the base layer 104.

Turning now to FIG. 3A, a side view schematically illustrating the components of FIGS. 2A-2F disposed adjacent to the cavity 120 of frame 111 is shown. This figure illustrates the components separate from the frame 111 for clarity of illustration. FIG. 3B illustrates these components disposed within the frame 111, as the commemorative plaque is normally configured according to same embodiments. In some embodiments, mat layer 103 may be coupled to the top surface 131 of the base layer 104 and text layer 105 may be disposed underneath the bottom surface 133 of the base layer. In this way, text 113 disposed on the text layer may be visible to a person viewing the plaque 100 from the front side 141 of the frame 111. Additionally, memorabilia 108, 109, 110 may be coupled to the top surface 131 of the base layer 104 such that the memorabilia is visible from the front side 141 of the frame 111 to a viewer.

In one embodiment, text layer 105 gives depth to the bottom surface of base layer 104 by offsetting the memorabilia 108, 109, 110 from the text layer 105 and because memorabilia 108, 109, and 110 and mat layer 103 are closer to a viewer's vantage point than text layer 105, due to intervening base layer 104, memorabilia 108, 109, and 110 and mat layer 103 create shadows on text layer 105. This effect (also referred to herein as a “shadow box” effect) is visually pleasing, as memorabilia 108, 109, and 110, which are the focal point of plaque 100, appear to be suspended in mid-air and appear to jump out of frame 111 towards a viewer. In some embodiments, this effect may be provided either by a substantially continuous base layer 104 or by spacer elements (illustrated below in FIG. 5).

With continued reference to FIG. 3, cushioning layer 106 may be disposed between text layer 105 and back plate 107 to protect the plaque elements from harmful impact from the back side 143 of frame 111. Additionally, encapsulation layer 102 may be disposed at least partially above base layer 104, mat layer 103, and memorabilia 108, 109, and 110 to provide protection of the plaque elements from the front side 141 of frame 111 and also couple the plaque elements inside the frame.

FIG. 3A further illustrates how the shape of the frame 111 cavity 120 compliments the other components of plaque 100. In one embodiment, the plaque 100 includes the frame 111, one or more memorabilia (e.g., 108, 109, 110) a base layer 104 and the encapsulation layer 102. Other embodiments can include one or more of the other components illustrated in FIGS. 3A and 3B, and other figures herein. Mat layer 103 may be coupled to the top surface 131 of base layer 104, and text layer 105 may be coupled to the bottom surface 133 of base layer 104, and memorabilia 108, 109, 110 may also be coupled to the top surface 131 of the base layer 104 adjacent to the mat layer 103. The base, mat, and text layers, 103, 104, 105 may be disposed within lower cavity portion 123, while memorabilia 108, 109, and 110 may partially extend into upper cavity portion 122. Mat layer 103 may be coupled to frame 111, thereby coupling base layer 104, memorabilia 108, 109, and 110, and text layer 105 as well. In one embodiment, mat layer 103 may be coupled to frame 111 at bottom internal surface 124. In a further embodiment, this coupling may be performed with caulk 114. Cushioning layer 106 and back plate 107 may also be disposed within lower cavity portion 123. In one embodiment, back plate 107 may be partially received by groove 121 to provide for engagement between the back plate 107 and the frame 111. Encapsulation layer 102 may be disposed within upper cavity portion 122 and may cover at least portions of the memorabilia 108, 109, 110, the mat layer 103, and/or the base layer 104. In one embodiment, the front most surface of encapsulation layer 102 may be substantially coplanar with the front side 141 of frame 111. In other embodiments, the front most surface of the encapsulation layer 102 may be substantially curvilinear and may not be substantially coplanar with the front side 141 of frame 111.

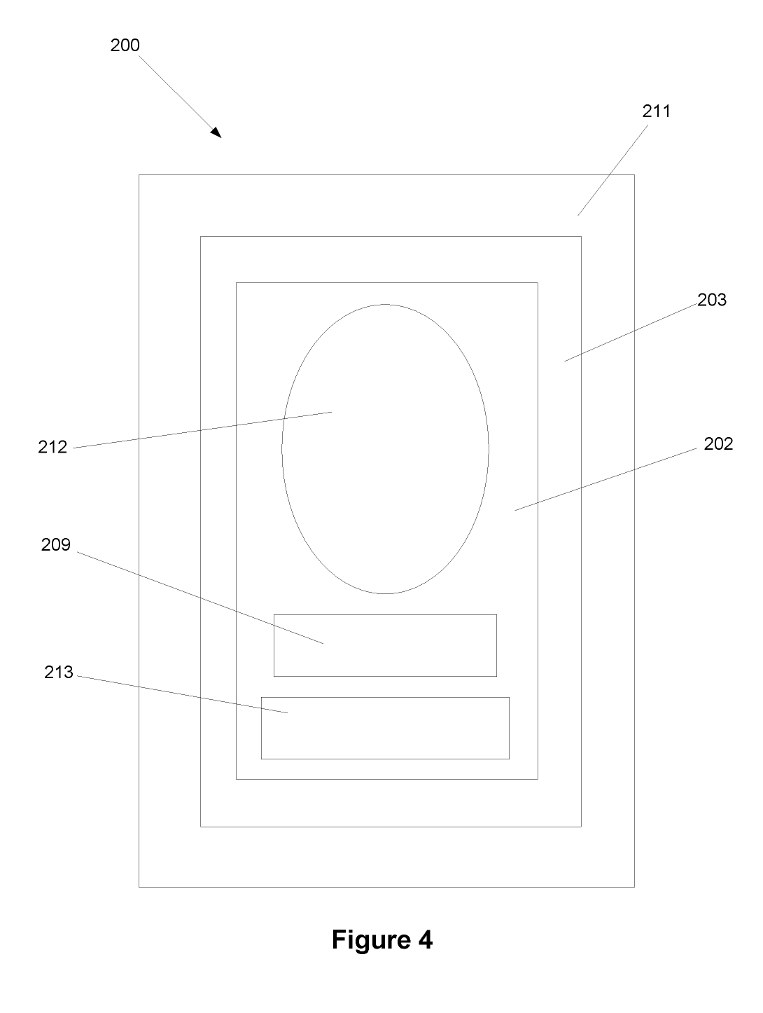

Turning now to FIG. 4, another embodiment of a plaque 200 is schematically illustrated and described in further detail. Plaque 200 may include a frame 211, a encapsulation layer 202, and a mat layer 203. These components may operate in a similar manner to their corresponding components in previously described embodiments. Also depicted are memorabilia 209 and 212. Memorabilia 209 and 212 may be any pieces of memorabilia and may include any number of pieces. Memorabilia 209 and 212 may be coupled to a base layer (not shown) in substantially the same manner as previously described embodiments. In one embodiment, memorabilia 209 is an officer or enlisted warfare badge. In another embodiment, memorabilia 212 is an installation, command, or unit patch. In further embodiments, memorabilia 212 may be either an embroidered patch or an adhesive patch. In yet another embodiment, memorabilia 212 may be an embroidered patch which is totally sealed with clear shrink. Plaque 200 may also contain text 213 on a text layer (not shown) in substantially the same manner as previously described embodiments. In one embodiment, text 213 may include a person's name, billet assignment, and/or date of tour information to accompany and inform memorabilia 209 and 212.

FIG. 5 schematically illustrates a side view of a third embodiment of a plaque 300. Similar to plaque 100 described above with reference to FIG. 3, plaque 300 can include a text layer 305, a cushioning layer 306 disposed below the text layer, and a back plate 307 disposed below the cushioning layer. Pieces of memorabilia can be offset from the text layer 305 by one or more spacer elements 304 and a mat layer 303 can be disposed over the text layer and adjacent to the spacer elements 304. A transparent encapsulation layer 302, for example, an acrylic resin, can be disposed at least partially over the text layer 305, mat layer 303, spacer elements 304, and memorabilia 308, 309, 310. In this way, the spacer elements 308, 309, 310 can offset the memorabilia 308, 309, 310 from the opaque text layer 305 to create a “shadow box” effect.

FIG. 6 is a block diagram depicting a process 400 of manufacturing the plaque shown in FIGS. 1-3, according to one embodiment. Process 400 includes providing a frame, wherein the frame has a cavity having a first portion and a second portion, the second portion defining a bottom internal surface within the frame as illustrated in block 401, providing a base layer having a top surface and a bottom surface as illustrated in block 403, and coupling a mat layer to the top surface of the base layer, wherein the mat layer has an opening extending through the mat layer as illustrated in block 405.

Process 400 further includes coupling at least one piece of memorabilia to the top surface of the base layer within the opening of the mat layer as illustrated in block 407 and coupling a text layer to the bottom surface of the base layer 104 as illustrated in block 409. In one embodiment, the text layer may contain text. In a further embodiment, the text may include a person's name and/or winging/graduation/promotion date information to accompany and inform the memorabilia.

Process 400 further includes coupling the mat layer to the bottom internal surface of the frame as illustrated in block 411. In one embodiment, coupling may be achieved by laying caulk along the bottom internal surface of the frame, pressing the mat layer onto the bottom internal surface of the frame and the caulk, and allowing the caulk to dry.

Process 400 further includes disposing a cushioning layer below the text layer as illustrated in block 413 and disposing a back plate below the cushioning layer as illustrated in block 415. In one embodiment, the back plate is locked in place. In another embodiment where caulk is used to couple the mat layer to the frame, the back plate is locked in place until the caulk dries. In a further embodiment, the back plate may be locked in place through the use of latching elements that couple the back plate to the frame. Alternatively, the back plate may be locked in place by being partially received by a groove within the second portion of the frame cavity.

Process 400 further includes pouring a liquid encapsulation layer over the mat layer, the memorabilia, and the base layer as illustrated in block 417. Preferably, this step is taken after the mat layer is sufficiently coupled to the frame, for example after the caulk has dried. In one embodiment, the encapsulation layer is acrylic resin. In another embodiment, the encapsulation layer is a two-part epoxy resin that is mixed and poured into the frame covering the mat layer, the base layer, and the memorabilia. In a further embodiment, the resin of the encapsulation layer is poured as three 1/16″ layers. In an even further embodiment, these three 1/16″ layers of the encapsulation layer are poured five hours apart.

Process 400 further includes allowing the encapsulation layer to solidify as illustrated in block 419. In one embodiment, this solidification can be achieved simply by waiting several hours. In another embodiment, this solidification can be achieved by curing the encapsulation layer in a heated oven.

In an alternative method (not shown), a mat layer is coupled to the top surface of a base layer and a text layer is coupled to the bottom surface of the base layer. One or more pieces or articles of memorabilia may be coupled to the top surface of base layer. In one embodiment, memorabilia can be an embroidered patch. In a further embodiment, memorabilia can be an embroidered patch sealed with clear shrink wrap. In this embodiment, a heat dryer is used to shrink the clear wrap around the embroidered patch of memorabilia until all the wrinkles are removed. The remaining steps are essentially identical to the method 400 previously described.

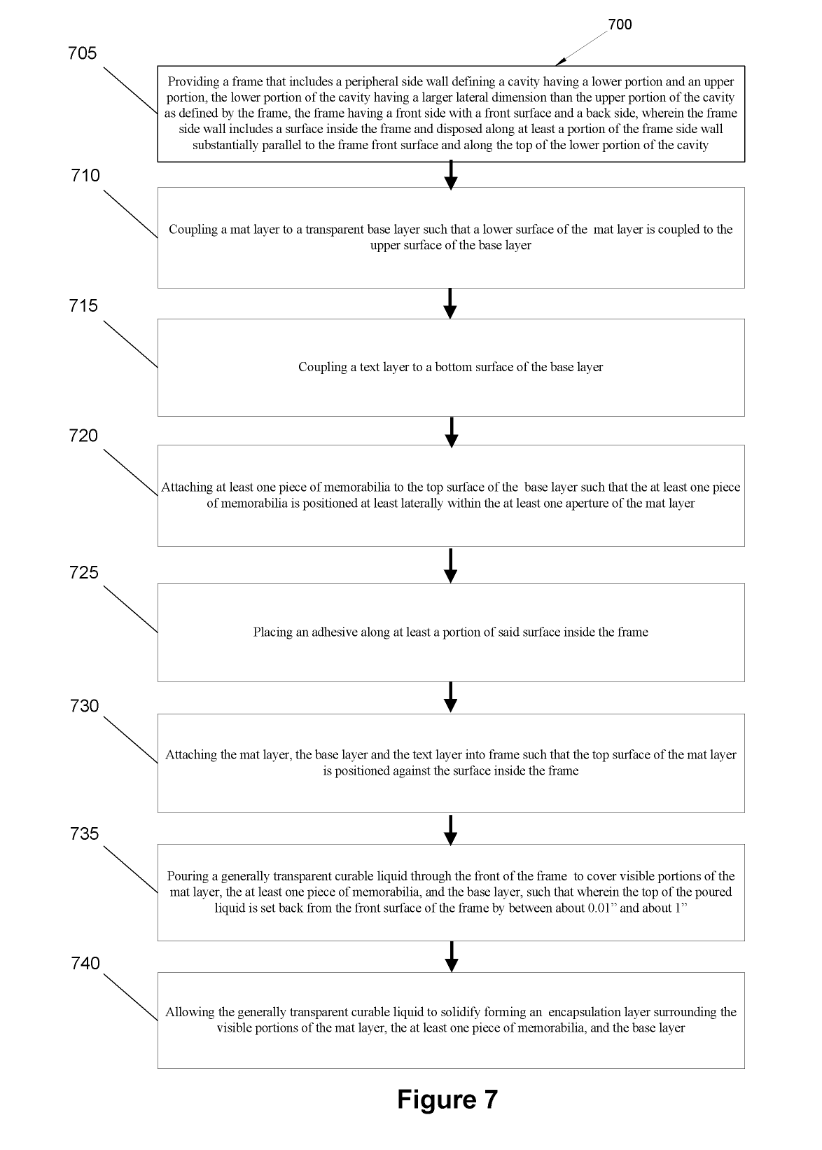

FIG. 7 illustrates another process 700 of manufacturing a commemorative plaque. At block 705, a frame is provided that includes a peripheral side wall defining a cavity having a lower portion and an upper portion, the lower portion of the cavity having a larger lateral dimension than the upper portion of the cavity as defined by the frame, the frame having a front side with a front surface and a back side. The frame side wall includes a surface inside the frame and disposed along at least a portion of the frame side wall substantially parallel to the frame front surface and along the top of the lower portion of the cavity.

At block 710, the process 700 includes coupling a mat layer to a transparent base layer such that a lower surface of the mat layer is coupled to the upper surface of the base layer. At block 715, a text layer is coupled to a bottom surface of the base layer. For example, the text layer can be glued to the bottom on a glass base layer. At block 720, at least one piece of memorabilia positioned to the top surface of the base layer such that the at least one piece of memorabilia is positioned at least laterally within the at least one aperture of the mat layer. At block 725, an adhesive is places along at least a portion of said surface inside the frame. In some implementations, the adhesive can be a clear adhesive caulk. At block 730, the process 700 includes attaching the mat layer, the base layer and the text layer into frame such that the top surface of the mat layer is positioned against the surface inside the frame.

At block 735, the process 700 includes pouring a generally transparent curable liquid through the front of the frame to cover visible portions of the mat layer, the at least one piece of memorabilia, and the base layer, such that wherein the top of the poured liquid is set back from the front surface of the frame by between about 0.01″ and about 1″. The cured liquid forms an encapsulation layer. In this process, poring the liquid to form the encapsulation layer can include pouring it in multiple layers, for example, each layer of about 1/32″ to about ⅛″. In some implementations, the curable liquid is poured in to have a total thickness dimension of between about 1/64″ and about 1″.

At block 740, the process 700 includes allowing the generally transparent curable liquid to solidify forming an encapsulation layer surrounding the visible portions of the mat layer, the at least one piece of memorabilia, and the base layer.

### Commemorative Plaque Example 1

In this example, the “Crystal Commemorative” is a series of memorabilia and plaques varying in sizes ranging from 4″×6″ to 18″×24.″ The 5″×7″ plaque includes a frame containing memorabilia of an officer or enlisted military rank, an officer or enlisted warfare badge, and an armed service emblem (U.S. Navy, U.S. Marine Corps, U.S. Army, U.S. Coast Guard). A single or double mat (e.g., mat layer) is glued to the glass (e.g., base layer), mat bottom down against the glass. A gloss white sheet of paper (e.g., text layer) containing a printed name and winging/graduation/promotion date (13) is glued to the underside of the glass (4). The military rank, warfare badges and armed service emblems are centered and glued to the top side of the glass. A bead of DAP Kwik Seal Plus clear adhesive caulk is laid down around the entire inside perimeter of the frame where the mat and frame will meet. When applying the caulk be sure to keep the caulk out of the groove for the back plate. The glued mat, glass and gloss paper backing are pressed into the frame thereby sealing the frame edges with the caulk before pouring of the encapsulation layer, for example, acrylic resin. The corrugated paper backing (e.g., cushioning layer) is placed between the gloss white paper and the frame back plate and locked in place until the caulk is dry. Ensure that the frame is level on all sides. After the caulk has dried, mix the Parks Super Glaze Ultra Glossy two part epoxy resin thoroughly. To minimize bubbles, mix the two part epoxy completely but slowly. It is generally preferable not to mix this material too fast (e.g., with a mixer bit with a high speed drill). Carefully measure both Part A and Part B of the epoxy resin in the separate measuring containers, per the instructions of the particular epoxy. Combine both parts in a third container, making sure to scrape all sides thoroughly. The proper mixing ratio is critical to ensure complete and uniform cure. Please note that proportions of epoxies may be “parts by volume” not by “weight.” Epoxy hardeners generally do not disperse and mix easily into the resin side. When mixing epoxy, the two-cup method is preferred. Measure and stir. Be sure to stir into the corners of the container, scraping the sides, bringing it up from the bottom to be mixed. It is preferable not to mix more than a quart at a time as it starts setting up in about ½ hour (depending on the particular brand of epoxy) and it should not be applied after it starts to gel.

If air is whipped into mixture, the air must be removed before curing. To remove large air bubbles at the surface simply prick them with any sharp object, such as a toothpick, or paper clip. Smaller clusters of air bubbles can be removed by passing a blow dryer or heat gun 6″ to 10″ above the surface from side-to-side in a sweeping motion. Taking care not to blow ripples into the epoxy.

Pour the epoxy resin inside the frame covering the glass, warfare badge and embroidered or adhesive patch with 1/16″ thick epoxy resin. Pour two more 1/16″ inch thick layers inside the frame until the total thickness of the acrylic is about 3/16″ deep. Wait five hours between each pour. The acrylic on top of the glass will render a suspended appearance to the devices glued to the glass.

### Commemorative Plaque Example 2

In this example, an 8″×10″ plaque consists of a frame containing an officer or enlisted warfare badge, and an Installation, Command, or Unit embroidered or adhesive patch. The embroidered patch must be totally sealed with clear shrink wrap paper and scotch tape sealing all seams at the back of the patch. A single or double mat is glued to the glass; mat bottom down. A gloss white sheet of paper containing a printed name, billet assignment and date of tour is glued to the underside of the glass. The warfare badge and unit embroidered or adhesive patch are centered and glued to the top side of the glass. After the embroidered patch has been sealed with the shrink wrap material and glued to glass, use a heat dryer to shrink the clear wrap around the embroidered patch until all the wrinkles are removed. A bead of DAP Kwik Seal Plus clear adhesive caulk is laid down around the entire inside perimeter of the frame where the mat and frame will meet. Be sure to keep the caulk out of the groove for the back plate. The glued mat, glass and gloss paper backing are pressed into the frame thereby sealing the frame edges with the caulk before pouring of the acrylic resin. The corrugated paper backing is placed between the gloss white paper and the frame back plate and locked in place until the caulk is dry. Ensure that the frame is level on all sides. After the caulk has dried, mix the Parks Super Glaze Ultra Glossy two part epoxy resin thoroughly. To minimize bubbles, mix the two part epoxy completely but slowly. Do not use a mixer bit with a high speed drill. Carefully measure both Part A and Part B of the epoxy resin in the separate measuring containers. Combine both parts in a third container, making sure to scrape all sides thoroughly.

If air is whipped into mixture it, it must be removed before curing. To remove large air bubbles at the surface simply prick them with any sharp object, such as a toothpick, or paper clip. Smaller clusters of air bubbles can be removed by passing a blow dryer or heat gun 6″ to 10″ above the surface from side-to-side in a sweeping motion.

Pour the epoxy resin inside the frame covering the glass, warfare badge and embroidered or adhesive patch with 1/16″ thick epoxy resin. Pour two more 1/16″ layers inside the frame until the total thickness of the acrylic is 3/16″ deep. Wait five hours between each pour. The acrylic on top of the glass will render a suspended appearance to the devices and embroidered patch that are glued to the glass.

While certain processes and operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations. Additionally, other implementations are within the scope of the following claims. In some cases, the actions recited in the claims can be performed in a different order and still achieve desirable results.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A commemorative plaque, comprising:
a frame including a peripheral side wall defining a cavity having a lower portion and an upper portion, the lower portion of the cavity having a larger lateral dimension than the upper portion of the cavity as defined by the frame, the frame having a front side with a front surface and a back side, wherein the frame side wall includes a surface inside the frame and disposed along at least a portion of the frame side wall substantially parallel to the frame front surface and along the top of the lower portion of the cavity;
a transparent base layer disposed inside the frame in the lower portion of the cavity, the base layer including a top surface disposed towards the frame front side and a bottom surface;
a text layer disposed inside the frame adjacent to the bottom surface of the base layer;
a mat layer disposed inside the frame, the mat layer including an upper surface, a lower surface, and at least one aperture extending from the upper surface to the lower surface of the mat layer, the lower surface of the mat layer being disposed adjacent to the top surface of the base layer and the top surface of the mat layer being disposed along the surface inside the frame;
at least one piece of memorabilia positioned over the top surface of the base layer and positioned at least laterally within the at least one aperture of the mat layer;
an encapsulation layer disposed inside the frame in part of the lower portion of the cavity in at least part of the upper portion of the cavity, the encapsulation layer including a substantially transparent cured liquid, the encapsulation layer having an outer surface disposed towards the front side of the frame, the encapsulation layer covering at least a portion of the at least one piece of memorabilia and the mat layer, wherein the outer surface of the encapsulation layer is set back from the front surface of the frame by between about 0.01″ and about 1″;
a cushioning layer disposed inside the frame and adjacent to the text layer such that the text layer is between the cushioning layer and the base layer; and
a back plate disposed adjacent to the cushioning layer on the opposite side of the cushioning layer than the text layer.

2. The commemorative plaque of claim 1, wherein the base layer comprises a rigid material having a thickness dimension between about 1 mm and about 25 mm.

3. The commemorative plaque of claim 1, wherein the frame side wall includes at least one groove interior to the frame, and at least one of the at least one of the base layer, the text layer, the mat layer, the cushioning layer, and the back plate is disposed inside the groove.

4. The commemorative plaque of claim 1, wherein the back plate is removably coupled to the frame using latching elements.

5. The commemorative plaque of claim 1, further comprising an adhesive, disposed on at least part of the frame side wall, coupling the upper surface of the mat layer to the frame side wall.

6. The commemorative plaque of claim 1, further comprising an adhesive, disposed on at least part of the frame side wall, coupling the base layer to the frame side wall.

7. The commemorative plaque of claim 1, further comprising at least one spacer element disposed between the base layer and the at least one piece of memorabilia.

8. The commemorative plaque of claim 7, wherein the encapsulation layer encapsulates the surfaces of the at least one piece of memorabilia that are not attached to the spacer.

9. The commemorative plaque of claim 1, wherein the encapsulation layer covers the top surface of the base layer that is not covered by the mat layer or the at least one piece of memorabilia.

10. The commemorative plaque of claim 1, wherein the encapsulation layer covers the upper surface of the mat layer that is not covered by the frame.

11. The commemorative plaque of claim 1, wherein the substantially transparent cured liquid comprises an acrylic resin.

12. The commemorative plaque of claim 1, wherein the substantially transparent cured liquid comprises two-part epoxy resin.

13. The commemorative plaque of claim 1, wherein the peripheral side wall forms a rectangular shape.

14. The commemorative plaque of claim 1, wherein the at least one piece of memorabilia is coupled to the base layer.

15. The commemorative plaque of claim 7, wherein the at least one piece of memorabilia is coupled to the at least one spacer element and the at least one spacer element is coupled to the base layer.

16. The commemorative plaque of claim 1, wherein the mat layer comprises more than one mat.

17. A method of making a commemorative plaque, comprising:
providing a frame that includes a peripheral side wall defining a cavity having a lower portion and an upper portion, the lower portion of the cavity having a larger lateral dimension than the upper portion of the cavity as defined by the frame, the frame having a front side with a front surface and a back side, wherein the frame side wall includes a surface inside the frame and disposed along at least a portion of the frame side wall substantially parallel to the frame front surface and along the top of the lower portion of the cavity;
coupling a mat layer to a transparent base layer such that a lower surface of the mat layer is coupled to the upper surface of the base layer;
coupling a text layer to a bottom surface of the base layer;
attaching at least one piece of memorabilia to the top surface of the base layer such that the at least one piece of memorabilia is positioned at least laterally within the at least one aperture of the mat layer;
placing an adhesive along at least a portion of said surface inside the frame;
attaching the mat layer, the base layer and the text layer into frame such that the top surface of the mat layer is positioned against the surface inside the frame;
pouring a generally transparent curable liquid through the front of the frame to cover visible portions of the mat layer, the at least one piece of memorabilia, and the base layer, such that wherein the top of the poured liquid is set back from the front surface of the frame by between about 0.01″ and about 1″; and
allowing the generally transparent curable liquid to solidify forming an encapsulation layer surrounding the visible portions of the mat layer, the at least one piece of memorabilia, and the base layer.

18. The method of claim 17, further comprising positioning a cushioning layer inside the frame and adjacent to the text layer such that the text layer is between the cushioning layer and the base layer, and positioning a back plate adjacent to the cushioning layer on the opposite side of the cushioning layer than the text layer.

19. The method of claim 17, wherein the base layer comprises a rigid material having a thickness dimension between about 1 mm and about 25 mm.

20. The method of claim 17, wherein the generally transparent curable liquid is poured in two of more layers each having a thickness dimension of about 1/16″.
